(19) United States
(12) Patent Application Publication
(10) Pub. No.: US 2008/0271958 A1
(43) Pub. Date: Nov. 6, 2008

(54) Elevator Door Lock

(76) Inventors: Muhidin A. Lelic, Manchester, CT (US); Pei-Yuan Peng, Manchester, CT (US); Bryan Robert Siewert, Westbrook, CT (US); Jacek F. Gieras, Glastonbury, CT (US); Michael Tracey, Cromwell, CT (US); Michael Flynn, Avon, CT (US); Thomas Malone, Avon, CT (US); Richard Fargo, Plainville, CT (US)

Correspondence Address: CARLSON GASKEY & OLDS, 400 W MAPLE STE 350, BIRMINGHAM, MI, 48009, US

(21) Appl. No.: 11/570,895

(22) PCT Filed: Sep. 23, 2004
(86) PCT No.: PCT/US2004/031501

§ 371 Date: Dec. 19, 2006

(51) Int. Cl. B66B 13/12

(52) U.S. Cl. 187/319

(57) ABSTRACT

An elevator door lock includes a locking member (40) that moves into an unlocked position responsive to contact with at least one door coupler member (32, 34). In disclosed examples, the locking member (40) comprises an arm that is pivotally supported by one of the door coupler members (34). The other coupler member (32) contacts a contact portion (42) on the locking member (40) to move the locking member into an unlocked position as the first coupler member (32) moves toward the second coupler member (34). In a disclosed example, a magnetic coupling between the coupler members maintains the locking member (40) in an unlocked position.

### 1. FIELD OF THE INVENTION

This invention generally relates to elevator door systems. More particularly, this invention relates to an arrangement for locking an elevator door.

### 2. DESCRIPTION OF THE RELATED ART

Elevators typically include a car that moves vertically through a hoistway between different levels of a building. At each level or landing, a set of hoistway doors are arranged to close off the hoistway when the elevator car is not at that landing and to open with doors on the car to allow access to or from the elevator car when it is at the landing. It is necessary to have the hoistway doors locked when the car is in motion or not appropriately positioned at a landing to prevent an individual from opening the hoistway doors, exposing the hoistway. Conventional arrangements include mechanical locks for keeping the hoistway doors locked under appropriate conditions.

Conventional arrangements include a door interlock that typically integrates several functions into a single device. The interlocks lock the hoistway doors, sense that the hoistway doors are locked and couple the hoistway doors to the car doors for opening purposes. While such integration of multiple functions provides lower material costs, there are significant design challenges presented by conventional arrangements. For example, the locking and sensing functions must be precise to satisfy codes. The coupling function, on the other hand, requires a significant amount of tolerance to accommodate variations in the position of the car doors relative to the hoistway doors. While these two functions are typically integrated into a single device, their design implications usually compete with each other.

The competing considerations associated with conventional interlock arrangements results in a significant number of call backs or maintenance requests. It is believed that elevator door system components account for approximately 50% of elevator maintenance requests and 30% of callbacks. Almost half of the callbacks due to a door system malfunction are related to one of the interlock functions.

There is a need in the industry for an improved arrangement that provides the security of a locked hoistway door, yet avoids the complexities of conventional arrangements and provides a more reliable arrangement that has reduced need for maintenance. This invention addresses that need with a unique elevator door lock assembly.

### SUMMARY OF THE INVENTION

An example elevator door lock device includes a locking member that is supportable for movement with a door panel and relative to the door panel. The locking member has a contact portion adapted to be directly contacted by a door coupler member to move the locking member into an unlocked position.

In one example, the locking member comprises an arm having a locking portion near one end. An opposite end of the arm is sized so that gravity biases the locking portion into a locked position.

An example elevator door coupler and lock assembly includes a first coupler member adapted to be supported for movement with one of an elevator car door or a hoistway door. A second coupler member, which cooperates with the first coupler member, is adapted to be supported on the other of the hoistway door or the car door. A locking member is supported by one of the coupler members and is moved into an unlocked position as the other coupler member moves toward the coupler member supporting the locking member.

In one example, the locking member is supported by a vane coupler member that is associated with the hoistway door. In this example, the locking member comprises an arm that pivots relative to the vane coupler member. A contacting portion of the locking member is moved by the other coupler member as a corresponding portion of that coupler member contacts the contacting portion.

One example includes a limiting member that limits the amount of movement of the locking member in the unlocking direction.

In one example, an electromagnetic coupling between the coupler members maintains them together and holds the locking member in the unlocked position.

The various features and advantages of this invention will become apparent to those skilled in the art from the following detailed description of a currently preferred embodiment. The drawings that accompany the detailed description can be briefly described as follows.

### BRIEF DESCRIPTION OF THE DRAWINGS

FIG. 1 schematically shows selected portions of an elevator system incorporating an assembly designed according to an embodiment of this invention.

FIG. 2 schematically shows selected portions of an example door lock assembly.

FIG. 3 is another view of the embodiment of FIG. 2.

FIG. 4 shows the arrangement of FIG. 3 in another operating position.

FIG. 5 shows an alternative embodiment.

### DETAILED DESCRIPTION OF THE PREFERRED EMBODIMENT

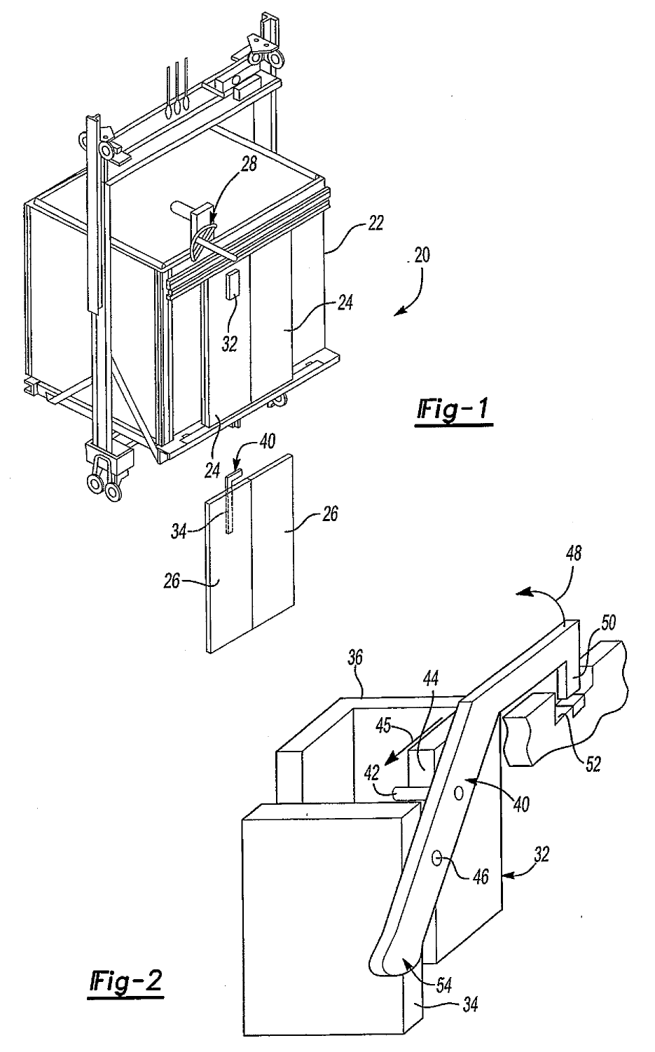

FIG. 1 schematically shows selected portions of an elevator system 20. An elevator car 22 has car doors 24 that remain closed as the car 22 travels through a hoistway, for example. When the car 22 arrives at a landing, the car doors 24 are aligned with hoistway doors 26 as known. A door mover 28 causes the car doors 24 to open as needed. The hoistway doors 26 will move with the car doors provided that an appropriate coupling between the doors causes the hoistway doors 26 to move with the car doors 24.

In the example of FIG. 1, a first coupler member 32 is supported for movement with the car doors 24. A second coupler member 34 is supported for movement with the hoistway doors 26. In one example, the first coupler member 32 and the second coupler member 34 operate based upon a magnetic coupling between them.

In the example of FIGS. 24, the first coupler member 32 comprises an electromagnet having a core 36 and a winding 38 (not shown in FIG. 2). The second coupler member 34 comprises an armature or vane. In one example, the second coupler member 34 comprises a piece of ferromagnetic material such that a magnetic coupling between the two coupler members becomes possible for driving the hoistway doors 26 with the car doors 24 as needed. In one example, the winding 38 receives power from a power source associated with the elevator car 22 to energize the electromagnet to provide a magnetic coupling between the first coupler member 32 and the second coupler member 34. The magnetic coupling allows moving the hoistway doors 26 with the car doors 24 without requiring the conventional roller and vane arrangement.

A locking member 40 is supported in a manner such that the locking member 40 moves between a locked position and an unlocked position responsive to contact with one of the coupler members. In the example of FIGS. 2-4, the locking member 40 is associated with the second coupler member 34. A contact portion 42 on the locking member 40, which comprises a pin in this example, is directly contacted by contacting surface 44 on the core 36 as the first coupler member 32 moves toward the second coupler member 34 as schematically shown by the arrows 45. In this example, the core 36 pushes the locking member 40 such that it pivots about an axis 46 as shown by the arrow 48. This motion causes a locking portion 50 to become disengaged from a locking recess 52, which is appropriately associated with a hoistway door header, in one example.

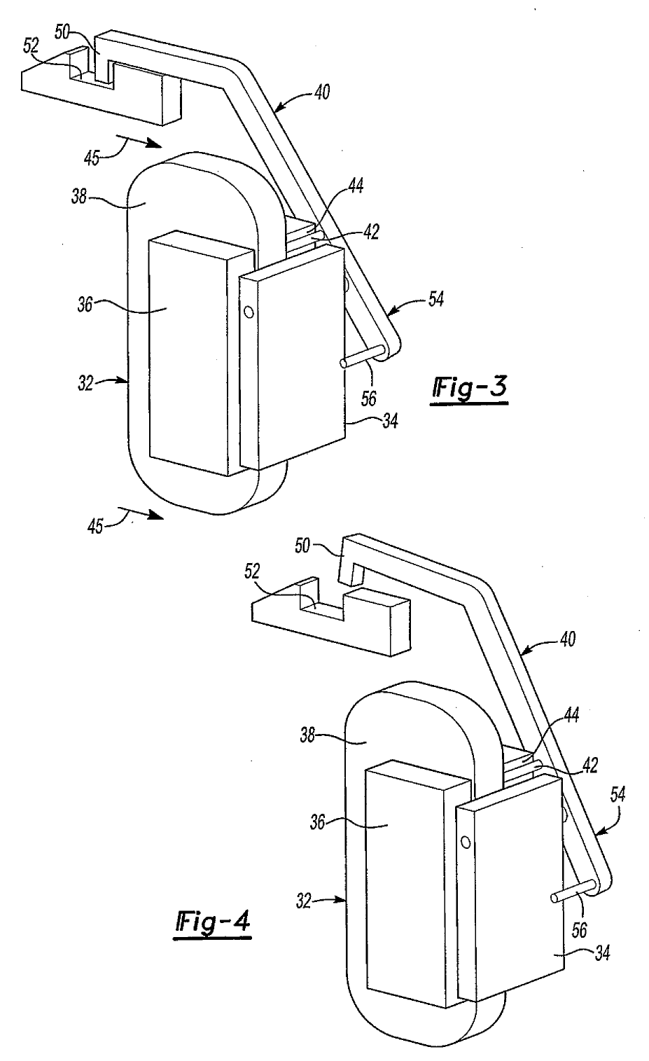

In this example the locked position can be appreciated by considering FIGS. 2 and 3. The unlocked position shown in FIG. 4 results from contact between the core 36 and the contacting portion 42 and sufficient movement of the first coupler member 32 toward the second coupler member 34 to cause the locking portion 50 to be moved clear of the locking recess 52. In one example, the dimensional relationships are set so that the locking portion 50 becomes clear of the locking recess 52 at approximately the same time that the core 36 contacts the second coupler member 34.

In the example of FIGS. 2-4, the locking member 40 comprises an arm having the locking portion 50 near one end. An opposite end 54 of the arm is sized so that the locking portion 50 is biased into the locked position by gravity.

This example also includes a limiting member 56, which comprises a pin similar to the pin used for the contact portion 42. The limiting member 56 contacts the second coupler member 34 and limits the amount of movement of the locking member 40 in the direction shown by the arrow 48 in FIG. 2, for example. In this example, the contact portion 42 and the limiting member 56 comprise pins supported on the arm of the locking member 40 that extend in a direction generally parallel to the axis 46 about which the locking member 40 pivots when moving between the locked and unlocked positions.

Electromagnetic interaction between the locking member 40 and the coupler members is not required. The forces of movement associated with contact between the locking member 40 and at least one of the coupler members is all that is required in this example for moving the locking member into the unlocked position. Upon separation of the coupler members 32 and 34, gravity draws the locking member 40 back into the locked position.

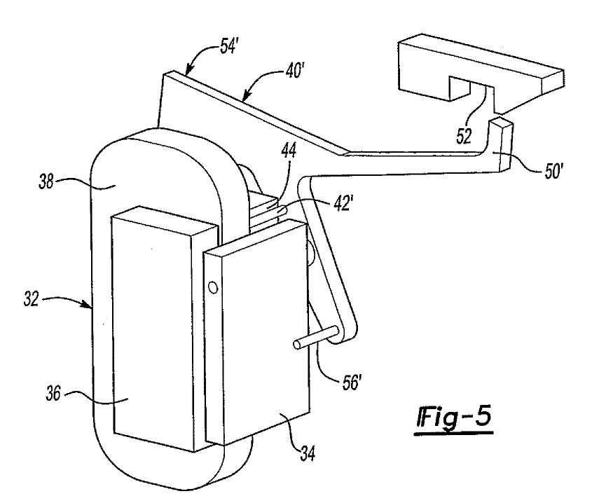

Another example is shown in FIG. 5 where the locking member 40′ has a slightly different configuration. In this example, the locking portion 50′ moves downward toward an unlocked position, rather than upward as was used in the previous example. In this example, the end 54′ of the locking member 40′ is heavier than the end including the locking portion 50′. Accordingly, the locking member 40′ is biased by gravity into the locked position. Movement of the locking member 40′ occurs in the same manner as that in the example of FIGS. 2-4.

While an electromagnetic coupling between the first coupler member 32 and the second coupler member 34 is used in this example, other arrangements for integrating the operation of a door coupler and door lock are within the scope of this invention. Those skilled in the art who have the benefit of this description will be able to select appropriate components and dimensions to meet the needs of their particular situation.

The disclosed examples provide an integrated door coupler and door lock arrangement that does not suffer from the drawbacks and shortcomings associated with previous arrangements. There are no complicated linkages or intermediary parts associated with the disclosed examples. Direct contact between one of the door coupler members and the locking member is all that is required for moving the locling member into an unlocked position. Therefore, the disclosed examples provide a reliable and streamlined arrangement.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. An elevator door lock device, comprising:
a locking member having a contact portion adapted to be directly contacted by an electromagnetic door coupler member that is operative to cause an elevator car door to move with an elevator hoistway door, direct contact between the locking member and the electromagnetic door coupler member causing the locking member to move into an unlocked position.

22. The device of claim 21, wherein the locking member comprises an arm having a locking portion near one end and wherein an opposite end of the arm is sized so that gravity biases the locking portion into a locked position.

23. The device of claim 22, including one of:
the locking portion is heavier than the opposite end; or
the opposite end is heavier than the locking portion.

24. The device of claim 21, wherein the electromagnetic door coupler member comprises a ferromagnetic core that is adapted to contact the contact portion of the locking member.

25. The device of claim 24, including a vane coupler member that is adapted to be contacted by the electromagnetic door coupler member and wherein the locking member is supported by the vane coupler member.

26. The device of claim 25, wherein the locking member is supported for pivotal movement relative to the vane coupler member into an unlocked position responsive to contact between the electromagnetic door coupler member and the contact portion.

27. The device of claim 25, wherein the locking member comprises an arm and the contacting portion comprises a pin supported on the arm, the locking member having a limiting member that contacts the vane coupler member to limit movement of the locking member relative to the vane coupler member.

28. An elevator door coupler and lock assembly, comprising:
an electromagnetic coupler member adapted to be supported for movement with one of an elevator car door or a hoistway door, the electromagnetic coupler member selectively receiving power to provide a magnetic coupling force;
a vane coupler member adapted to be supported on the other of the hoistway door or the elevator car door; and
a locking member supported by one of the electromagnetic coupler member or the vane coupler member for movement into an unlocked position responsive to contact between the locking member and the other coupler member as the other coupler member moves toward the one of the coupler members.

29. The assembly of claim 28, wherein the locking member is supported by the vane coupler member and pivots relative to the vane coupler member responsive to the electromagnetic coupler member contacting a contacting portion of the locking member.

30. The assembly of claim 29, wherein the contacting portion comprises a pin that extends in a direction generally parallel to an axis about which the locking member pivots relative to the vane coupler member.

31. The assembly of claim 30, wherein the electromagnetic coupler member has a core that contacts the pin.

32. The assembly of claim 29, including a limiting member that limits movement of the locking member in the direction toward the unlocked position.

33. The assembly of claim 28, wherein the locking member comprises an arm having a locking portion near one end and wherein an opposite end of the arm is sized so that gravity biases the locking portion into a locked position.

34. The assembly of claim 33, wherein the locking portion is heavier than the opposite end.

35. The assembly of claim 33, wherein the opposite end is heavier than the locking portion.

36. An elevator door assembly, comprising:
at least one elevator car door;
at least one hoistway door;
a first coupler member supported for movement with the car door;
a second coupler member supported for movement with the hoistway door, the first and second coupler members coupling the hoistway door and the car door such that the doors move together; and
a locking member positioned to be contacted by one of the coupler members as the one coupler member moves toward the other coupler member and moved into an unlocked position as the one of the coupler members continues to move toward the other coupler member.

37. The assembly of claim 36, wherein the locking member is pivotally supported on the second coupler member and has a contact portion that directly contacts a corresponding portion of the first coupler member.

38. The assembly of claim 36, wherein the first coupler member holds the locking member in the unlocked position when the first coupler member is magnetically coupled with the second coupler member.

39. The assembly of claim 36, wherein the locking member comprises an arm having a locking portion near one end of the arm and an opposite end of the arm is sized so that the locking portion is biased by gravity into a locked position.
